(19) United States
(12) Patent Application Publication
(10) Pub. No.: US 2014/0249729 A1
(43) Pub. Date: Sep. 4, 2014

(54) Hill Start in a Vehicle

(71) Applicant: CATERPILLAR INC., Peoria, IL (US)

(72) Inventors: Timothy D. Schwartz, Washington, IL (US); James Landes, East Peoria, IL (US); David R. Wisley, Peoria, IL (US); Rodney L. Menold, Peoria, IL (US)

(73) Assignee: Caterpillar Inc., Peoria, IL (US)

(21) Appl. No.: 13/782,448

(22) Filed: Mar. 1, 2013

(51) Int. Cl. B60T 7/12

(52) U.S. Cl. CPC B60T 7/12
USPC 701/70

(57) ABSTRACT

A hill brake system in a vehicle uses a controller to determine when a number of conditions, such as being stopped on an incline, are met and then automatically applies a braking force at least equal to a calculated grade load, that is, gravitational force. Using drive train measurements and known drivetrain characteristics, a rimpull force is calculated after release of an operator-controlled brake and the automatically applied braking force is reduced corresponding to the rimpull force generated by the drivetrain. The automatically applied braking force is released when any of several conditions are met including uphill motion of the vehicle or expiration of a timeout timer.

### TECHNICAL FIELD

The present disclosure relates to an automated braking system for use in preventing downhill motion when starting a vehicle on an incline.

### BACKGROUND

Heavy equipment, such as large earthmoving vehicles, must often stop on inclines. However, restarting from an incline may cause a challenge for an operator wishing to avoid rolling downhill while accelerating from the stopped position. In many cases, the operator will “two foot” the process, applying the left foot to the brake and the right foot to the accelerator so that the engine torque increases to a point where releasing the brake will not cause downhill motion.

This process, however, has several drawbacks. Unintended motion downhill is one. The two foot operation, in addition to simply being a nuisance or a distraction to the operator, causes the brakes to be applied over increasing engine torque and may cause undue wear on the brakes, as well as undue wear on drive train components such as a torque converter, gearbox, and/or drive motors.

EP1581418 to Lauri, discloses a hill brake system that selects a suitable starting gear and determines a minimum torque and engine speed required to overcome a traveling resistance of the vehicle and then releases a clutch and the brake as the minimum engine speed and torque are achieved. Lauri, however fails to disclose determining delivered rimpull force at a drive wheel of the vehicle and reducing a braking force proportional to the rimpull.

### SUMMARY OF THE DISCLOSURE

In a first aspect, a method of providing a hill brake in a vehicle includes applying a braking force required to prevent the vehicle from rolling in a downhill direction after an operator-controlled brake is released, calculating a rimpull at a drive wheel of the vehicle, and reducing the braking force as the rimpull increases.

In another aspect, a controller that provides a hill brake in a vehicle on an incline during acceleration from a stop includes a rimpull subsystem that determines force at a drive wheel of the vehicle, a grade load subsystem that determines a downhill force on the vehicle, a braking subsystem that supplies a braking force sufficient to prevent downhill motion of the vehicle, wherein the braking force decreases corresponding to an increase in force at the drive wheel.

A method of providing a hill brake in a vehicle may include determining that the vehicle is on an incline, determining that the vehicle is stopped, determining that the vehicle is configured for uphill propulsion, and calculating a grade load on the vehicle. The method may also include calculating a braking force approximately equal to the grade load, applying the braking force via a braking system in the vehicle, and sensing release of a brake pedal. The method may continue after sensing release of the brake pedal and until a trigger event is reached by calculating a rimpull at a drive wheel of the vehicle, reducing the braking force corresponding to an increase in rimpull, and upon reaching the trigger event, releasing the braking force.

### BRIEF DESCRIPTION OF THE DRAWINGS

FIG. 1 is an illustration of a vehicle on an incline;

FIG. 2 is a simplified schematic diagram of the vehicle of FIG. 1 showing components associated with a hill brake system;

FIG. 3 is a block diagram of an exemplary controller operative in the hill brake system; and

FIG. 4 is a flow chart of an exemplary method of providing hill start in a vehicle.

### DETAILED DESCRIPTION

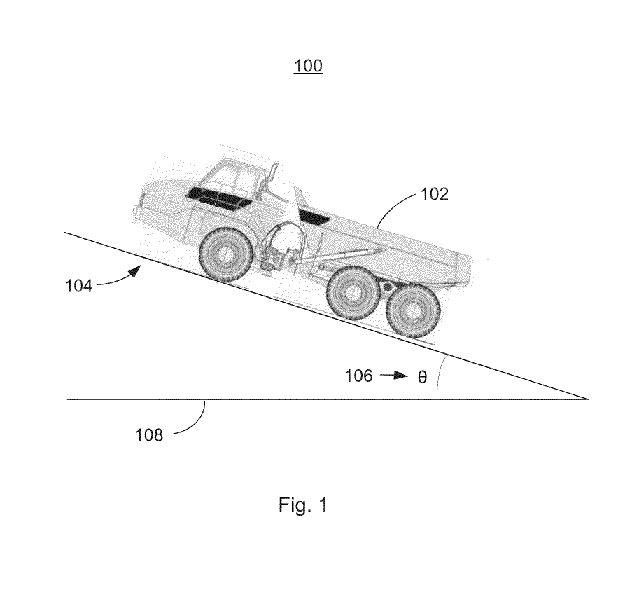

FIG. 1 is an illustration of a work site 100 showing a vehicle 102 on an incline 104. The incline 104 may be measured by an angle θ 106 from a level reference 108. In the illustration, the vehicle 102 is shown facing uphill, that is so that driving in a forward gear causes uphill motion. When discussing a hill brake, it is equally valid that the vehicle 102 may be facing downhill such that driving in a reverse gear causes uphill motion.

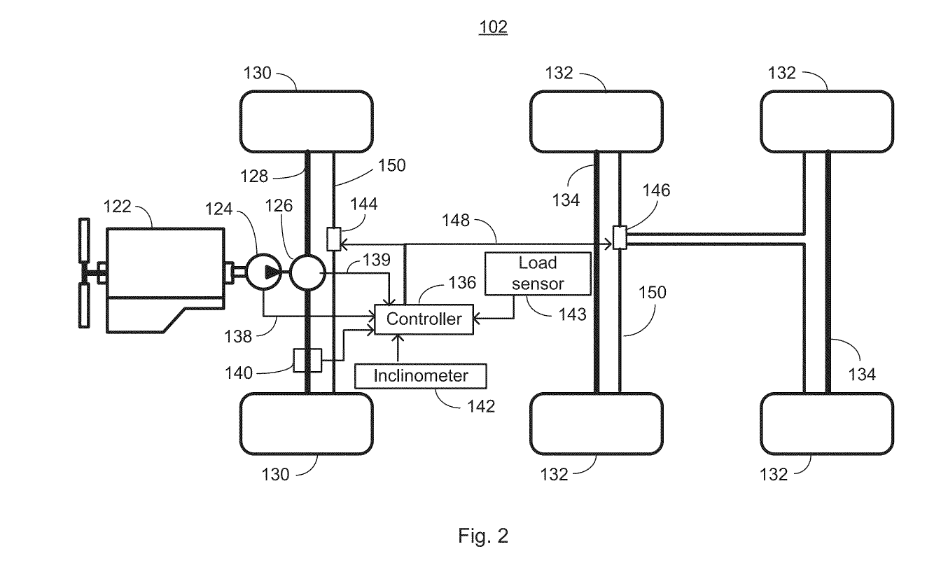

FIG. 2 is a simplified schematic diagram of the vehicle 102 of FIG. 1 showing components associated with a hill brake system. The vehicle 102 may include an engine 122, coupled to a torque converter 124, whose output drives a transmission 126 and ultimately delivers torque via an axle 128 to drive wheels 130.

In an embodiment, wheels 132 may be unpowered and may carry a payload bearing element of the vehicle 102. For example, the vehicle 102 may be an articulated truck. In other embodiments, the vehicle 102 may be any of a number of machines including, but not limited to, earthmovers, dump trucks, mining equipment, etc. In these other embodiments, the exact arrangement of drive train and drive wheels 130 may differ from that described with respect to the exemplary embodiment discussed here in detail.

The wheels 132 may be connected by respective axles 134. The controller 136 may be coupled via a sense line or lines 138 to the torque converter 124. The controller 136 may also receive a current gear selection from the transmission 126 via a sense line 139. A sensor 140 may report axle speed and/or ground speed to the controller 136. An inclinometer 142 may report vehicle angle to the controller 136. The inclinometer 142 may report vehicle angle both front-to-back and side-to-side as well as positive or negative front-to-back angles depending on the orientation of the vehicle 102 with respect to the incline 104. A load sensor 143 may report a weight of the payload of the vehicle 102 or some value associated with the payload weight, such as readings from strain gauges, etc. In an embodiment, the payload may be determined using other instruments, such as an accelerometer.

The controller 136 may provide a control current to a drive wheel brake valve 144 and an unpowered wheel brake valve 146 via an electrical connection 148. Other embodiments, for example, those using a different braking mechanism, may use a different control mechanism for applying braking force. For example, if the brake being used is a driveline brake and not a hydraulically operated wheel disk or rotor brake, a different control scheme may be implemented in keeping with the current disclosure. The respective brake valves 144 and 146 may increase pressure in brake lines 150 to cause application of brakes (not depicted) to transmit a braking force to the wheels 130, 132. Note that the hill brake itself is not a single, standalone mechanism. The hill brake is a combination of sensors and existing braking mechanisms operated at the direction of the controller 136 under a very limited set of vehicle operating conditions.

The embodiment illustrated in FIG. 2 is an engine/torque converter/transmission drivetrain. In another embodiment, the drivetrain may be a generator/electric motor set that may include one more electric power inverters, batteries, and/or reduction gears. In the discussion that follows, the nature of the drivetrain is relevant to the extent that a determination of rimpull is available.

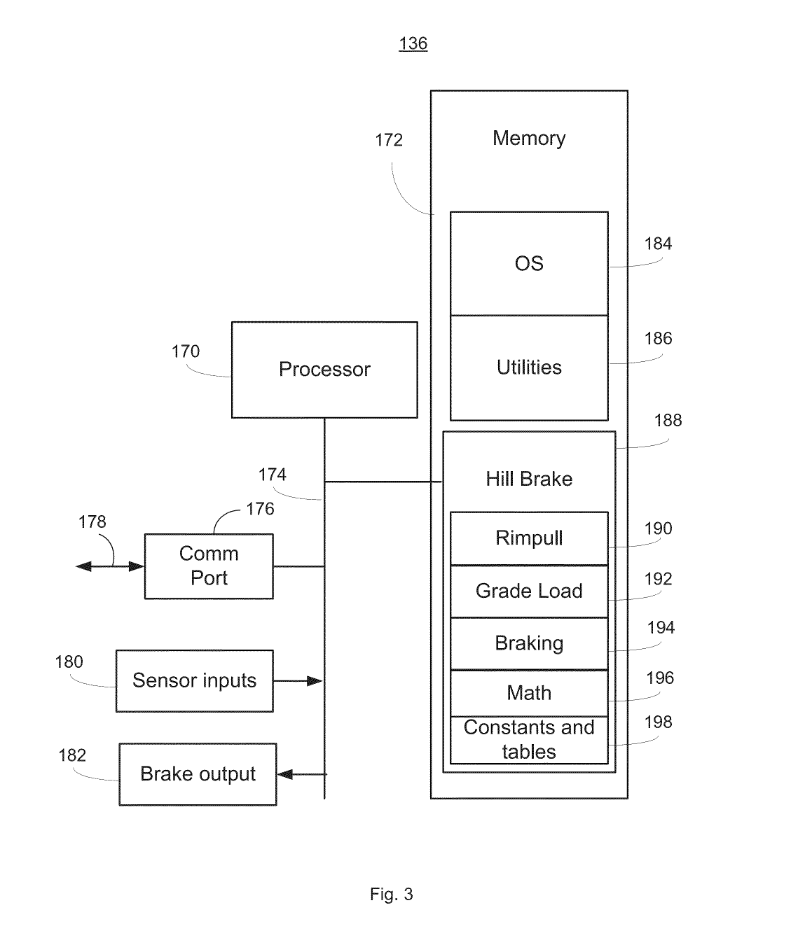

FIG. 3 is a block diagram of an exemplary controller 136 operative to provide hill braking. The controller 136 may include a processor 170, a memory 172 and a data bus 174 that communicates information between physical elements of the controller 136. The controller 136 may include a communication port 176 that supports data communication with an engine computer or other equipment, such as operator station electronics, via a vehicle network 178. The controller 136 may also include a sensor input circuit 180 that may receive data from, for example, the axle and/or groundspeed sensor 140, the inclinometer 142, and the load sensor 143. The controller 136 may also include a brake output circuit 182 that provides a drive current to the brake valves 144 and 146.

The memory 172 may be a physical memory including volatile and/or nonvolatile physical memory including but not limited to RAM, ROM, programmable arrays, flash memory, etc. The controller 136 may include an operating system 184, such as a real-time operating system (RTOS) or other known operating system, utilities 186 that may support routine functions such as communication via the communication port 176, diagnostics, etc.

The memory 172 may also include a hill brake application 188 that operates to provide hill braking as described. The hill brake application 188 may include a rimpull subsystem 190, a grade load subsystem 192, a braking subsystem 194, a math subsystem 196, and various constants or lookup tables 198. In an embodiment, the math subsystem 196 may be a proportional controller.

The controller 136 may be a standalone unit as depicted, or may be included as a function in a different physical computer-oriented processor or engine controller (not depicted). Other embodiments of a standalone controller, the actual functions may be implemented in a different manner, such as a field programmable gate array or the use of different specific subsystem combinations that achieve a functional equivalent.

### INDUSTRIAL APPLICABILITY

In general, the ability to provide a hill brake for a vehicle 102 increases both site safety and operator satisfaction. Because, for at least a limited period of time, the vehicle 102 is not in danger of rolling downhill there is a reduced threat to personnel, other vehicles, or obstructions that may be downhill of the vehicle 102. Further, an operator may be able to release the foot brake and apply the throttle in an orderly manner without undue worry regarding timing of the brake and throttle operation and as a result may both reduce operator stress and the reduce the risk of damage to the brakes or drivetrain. As a result, the operator may be able to increase his or her attention to the surrounding work area and note potential safety hazards associated with moving the vehicle 102. Using rimpull as a measure of available force increases the accuracy of the calculation of braking force required to offset grade load and may allow more accurate release of the braking force during operation of the hill brake.

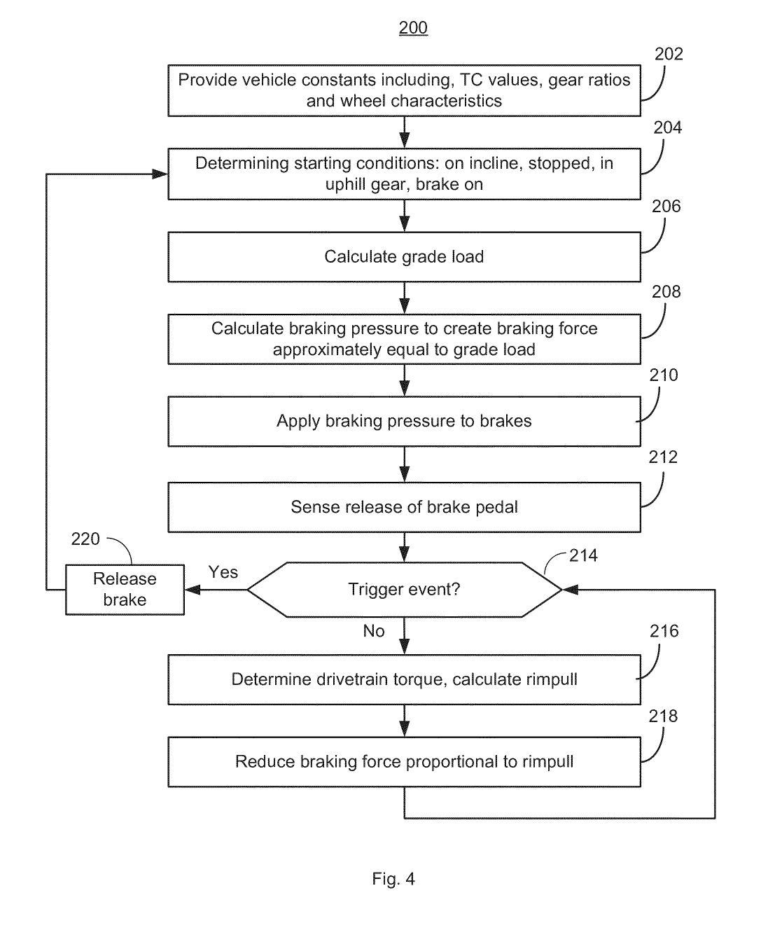

FIG. 4 is a flow chart of an exemplary method 200 of providing hill start in a vehicle 102. At block 202, various information about the vehicle, including torque converter constants, gear ratios of the transmission 126, and wheel characteristics may be provided. For example, for a given torque converter 124, the ratio of input speed to output speed often predicts an output torque with a high degree of accuracy.

At block 204, vehicle conditions may be evaluated to determine if hill brake operation is appropriate. For example, the vehicle 102 should be on an incline. If the vehicle 102 is on flat ground there is no requirement for use of the hill brake. To determine if the vehicle 102 is on an incline 104, an inclinometer 142 may be used. In an embodiment, if the incline 104 is less than a few percent, the hill brake may also be disabled. A determination may also be made that the vehicle 102 is in fact stopped as the use of the hill brake is not indicated while the vehicle 102 is still in motion.

A determination may be made that the vehicle 102 is in an uphill gear. For example, if the vehicle 102 is facing uphill, a forward gear must be engaged. On the other hand, if the vehicle 102 is facing downhill, a reverse gear must be engaged. Last, a foot brake or other operator-activated brake must be applied. There is no intent for the hill brake to operate over a long period as a parking brake.

At block 206, the grade load may be determined by developing the weight of the payload using a load sensor 143, adding the known or estimated weight of the vehicle 102 and multiplying the result by the sine of the angle of incline θ 106. Estimated vehicle weight may include fuel weight based on fuel tank level sensing and the density of the fuel. The grade load represents the amount of downhill force that must be overcome by the brakes to prevent downhill movement of the vehicle 102.

At block 208, the amount of braking force required to equal, or in an embodiment, slightly surpass the grade load is used to calculate an amount of braking pressure required to yield the necessary braking force. For a given vehicle 102, the braking pressure, that is, the amount of pressure on brake fluid in the brake lines 150 may be correlated to the amount of braking force applied at the brakes. In an embodiment, a table of braking force to braking pressure may be developed and stored in the memory 172, for example in the constants and tables 198.

At block 210, the required braking pressure may be applied via a signal from the controller 136 to the brake valves 144 and 146. In various embodiments, the braking pressure may be applied before release of the foot pedal or other operator activated braking mechanism, or may be applied concurrently with release of the foot pedal or other operator activated braking mechanism. In an embodiment, braking force may be increased slightly over the minimum calculated in order to account for component wear or sensor inaccuracies.

At block 212, release of the foot pedal or other operator activated braking mechanism may trigger actual operation of the hill brake.

At block 214, an evaluation may be made regarding the occurrence of one or more trigger events related to exit from the hill brake operating mode. For the purpose of illustration it will be assumed that the initial entry to block 214 occurs prior to any trigger event and the ‘no’ branch is taken from block 214 to block 216.

At block 216, rimpull, that is, force applied at the ground by the drive wheels 130 may be calculated using drivetrain torque information. For example, input and output speed at the torque converter 124 in combination with the known forward or reverse gear at the transmission 126 may be used to develop axle torque at the drive wheels 130. Using known size information for the wheels 130 the axle torque may be converted to rimpull. For example, the newton-meters of axle torque can be converted to rimpull using the size difference between the axle and the outside diameter of the wheel using the simple equation torque=force×distance. A known rolling resistance of the vehicle may be subtracted from the rimpull.

In the case of an electric motor drivetrain, motor torque may be measured using a torque sensor or may be calculated using, for example, a flux calculation and measured current. As discussed above, rimpull may then be calculated using the motor torque, any intervening gearing, and wheel characteristics.

At block 218, the amount of rimpull may be subtracted from the grade load to develop a new braking force requirement. As above, the braking force requirement may be translated to a braking pressure and subsequently the controller 136 may adjust the control current to the brake valves 144 and 146 to reduce the braking pressure as calculated. The braking force may be reduced proportional to the increase in rimpull. For example, braking force may be reduced linearly as a function of grade load force—rimpull. In another embodiment, the braking force may be reduced exponentially so that as rimpull gradually increases the braking force may be reduced only a small amount and as rimpull approaches grade load, the braking force is reduced more quickly. Execution may continue at block 214.

Returning to block 214, a number of trigger events may be evaluated to determine whether to repeat the loop. First, a timer may be checked to determine if a timeout period has expired related to an amount of time the hill brake function has been active that is, from the release of the brake by the operator at block 212 to the current time. As mentioned above, the goal is not to use the hill brake as a parking brake therefore a limit on how long the hill brake is active may be set to a relatively short period of time, such 1 to 3 seconds. In an embodiment where the timeout period is two seconds, the operator is given sufficient time to activate the throttle and increase the torque of the engine 122 but is not given enough time to stand up and exit the cab before an alarm sounds and/or the brake is released. Alternatively, an operator may desire to roll downhill in some cases and the relatively short timeout period allows such operation without undue interruption.

A second trigger event may be one the rimpull is greater than the grade load. At this point, braking force is no longer required and the braking force may be reduced to zero by appropriate reductions in braking pressure.

A third trigger event may be actual uphill movement of the vehicle 102 using information from an axle or groundspeed sensor 140.

A fourth trigger event may be uphill rotation of one or more drive wheels 130 using information from the axle or groundspeed sensor 140.

Upon occurrence of any of the trigger events, the ‘yes’ branch may be taken from block 214 to block 220 where the brakes are released via a change in control current from the controller 136 to the brake valves 144 and 146.

Execution may continue at block 204 to determine when it may be appropriate to reactivate the hill braking function.

What is claimed is:

1. A method of providing a hill brake in a vehicle comprising:
applying a braking force required to prevent the vehicle from rolling in a downhill direction after an operator-controlled brake is released;
calculating a rimpull at a drive wheel of the vehicle; and
reducing the braking force as the rimpull increases.

2. The method of claim 1, wherein reducing the braking force comprises removing the braking force after detection of a trigger event.

3. The method of claim 2, wherein the trigger event is one of an uphill motion of the vehicle and an uphill rotation of the drive wheel.

4. The method of claim 2, wherein the trigger event is expiration of a timeout period measured from a time the operator-controlled brake is released.

5. The method of claim 1, where calculating rimpull comprises:
determining torque at an output of a torque converter;
determining a current gear setting;
calculating axle torque from the output power and a gear ratio of the current gear setting; and
calculating rimpull using a known conversion of axle torque to rimpull force less a known rolling resistance.

6. A controller that provides a hill brake in a vehicle on an incline during acceleration from a stop, the controller comprising:
a rimpull subsystem that determines force at a drive wheel of the vehicle;
a grade load subsystem that determines a downhill force on the vehicle; and
a braking subsystem that supplies a braking force sufficient to prevent downhill motion of the vehicle, wherein the braking force decreases corresponding to an increase in force at the drive wheel.

7. The controller of claim 6, wherein the braking subsystem comprises:
an output driver that applies an electrical current to a braking control valve that generates a braking pressure corresponding to the electrical current to provide a braking pressure sufficient to generate the required braking force.

8. The controller of claim 7, further comprising a calculation function that receives the downhill force from the grade load subsystem, determines a required braking force to offset the downhill force, and reports the required braking force to the braking subsystem.

9. The controller of claim 6, wherein the rimpull subsystem, to determine force at the drive wheel, determines torque at an output of a torque converter, determines a current gear setting to calculate axle torque and a gear ratio of the current gear setting and calculates rimpull using a known conversion of axle torque to rimpull force less rolling resistance.

10. The controller of claim 6, wherein the grade load subsystem includes:
a first input that receives data used to calculate an angle of the vehicle;
a second input that receives a signal corresponding to payload weight; and
a calculation function that adds a vehicle weight to the payload weight and calculates the downhill force on the vehicle using the data from the inclinometer.

11. A method of providing a hill brake in a vehicle comprising:
determining that the vehicle is on an incline;
determining that the vehicle is stopped;
determining that the vehicle is configured for uphill propulsion;
calculating a grade load on the vehicle;
calculating a braking force approximately equal to the grade load;
applying the braking force via a braking system in the vehicle;
sensing release of a brake pedal;
after sensing release of the brake pedal and until a trigger event is reached:
calculating a rimpull at a drive wheel of the vehicle; and
reducing the braking force corresponding to an increase in rimpull; and
upon reaching the trigger event, releasing the braking force.

12. The method of claim 11, wherein the trigger event is expiration of a timeout period.

13. The method of claim 11, wherein the trigger event is the rimpull greater than the grade load.

14. The method of claim 11, wherein the trigger event is uphill motion of the vehicle.

15. The method of claim 11, wherein the trigger event is uphill rotation of the drive wheel.

16. The method of claim 11, wherein calculating the grade load comprises:
determining a payload weight;
adding the payload to a known vehicle weight to develop a gross vehicle weight;
determining a vehicle angle; and
computing the grade load as a mathematical function of the vehicle angle and the gross vehicle weight.

17. The method of claim 11, further comprising:
converting the required braking force to a braking pressure required to generate the required braking force using a predetermined mapping function; and
applying the braking pressure.

18. The method of claim 17, wherein applying the braking pressure comprises activating a brake control valve with an electrical current value corresponding to the required braking pressure.

19. The method of claim 11, wherein calculating the rimpull comprises:
measuring electrical motor torque; and
converting the electrical motor torque to rimpull using drivetrain and wheel characteristics.

20. The method of claim 11, wherein reducing the braking pressure corresponding to the rimpull comprises adjusting the braking force to be approximately equal to the grade load minus the rimpull.
